(19) United States
(12) Patent Application Publication
(10) Pub. No.: US 2019/0211786 A1
(43) Pub. Date: Jul. 11, 2019

(54) Valve Assembly for an Injection Valve and Injection Valve

(71) Applicant: CPT Group GmbH, Hannover (DE)

(72) Inventors: Mauro Grandi, Livorno (IT); Stefano Filippi, Castel' Anselmo Collesalvetti (IT); Francesco Lenzi, Livorno (IT); Valerio Polidori, Livorno (IT)

(73) Assignee: CPT Group GmbH, Hannover (DE)

(21) Appl. No.: 16/327,422

(22) PCT Filed: Aug. 9, 2017
(86) PCT No.: PCT/EP2017/070243

§ 371 Date: Feb. 22, 2019

(30) Foreign Application Priority Data
Aug. 23, 2016 (DE) 16185346.0

(51) Int. Cl. F02M 51/06

(52) U.S. Cl. CPC F02M 51/0614

(57) ABSTRACT

Some embodiments include: a valve body; a valve needle; a calibration spring biasing the needle to close a fluid outlet; an armature to actuate the needle; and an armature stopper comprising an armature support, a circumferential side wall, and a circumferential clamping portion. The armature stopper is coaxial with the valve needle below the armature, facing the armature and providing a stop for the armature in the closing direction. The clamping portion includes a circumferential gutter formed by a base portion, an inner wall and an outer wall. The inner wall is part of the circumferential side wall with a smaller radial extension than the outer wall and is closer to the valve needle. The outer wall extends circumferentially around the inner wall to form a press-fit area for press-fitting the armature stopper into the valve body.

### CROSS-REFERENCE TO RELATED APPLICATIONS

This application is a U.S. National Stage Application of International Application No. PCT/EP2017/070243 filed Aug. 9, 2017, which designates the United States of America, and claims priority to DE Application No. 16185346.0 filed Aug. 23, 2016, the contents of which are hereby incorporated by reference in their entirety.

### TECHNICAL FIELD

The present disclosure relates to valves. Various embodiments may include valve assemblies for fluid injection valves and/or fluid injection valves, e.g. a fuel injection valve of a vehicle.

### BACKGROUND

Injection valves for internal combustion engines must be able to dose fluids even in the case of high fuel pressure. One design to ensure this is the “free-lift” design, which is disclosed e.g. in document WO 2015/052281 A1. According to this design, the armature of the electro-magnetic actuator unit travels about a “pre-stroke gap” or “free lift gap” before it engages the needle to open the injector. Thus, kinetic energy is accumulated before the actual opening. With injection valves of the “free lift”-design as well as with other designs, needle bounce events or post injections cause increased emissions. Sometimes, an anti-bounce armature spring is arranged below the armature to dampen the armature during closing. This spring, however, needs to be a low-stiffness spring and has the tendency to buckle, causing needle bounce.

### SUMMARY

The teachings of the present disclosure describe a valve assembly for an injection valve and an injection valve that overcome the above mentioned difficulties and/or provide a stable performance with a high maximum pressure. For example, some embodiments of the teachings herein include a valve assembly (3) for an injection valve (1), comprising a valve body (4) with a central longitudinal axis (L) comprising a cavity (9) with a fluid inlet portion (5) and a fluid outlet portion (7), a valve needle (11) axially moveable in the cavity (9), the valve needle (11) preventing a fluid flow through the fluid outlet portion (7) in a closing position and releasing the fluid flow through the fluid outlet portion (7) in further positions, a calibration spring (18) axially biasing the valve needle (11) in a closing direction towards the fluid outlet portion (5), a movable armature (23) of an electro-magnetic actuator unit (19) being designed to actuate the valve needle (11), an armature stopper (27) comprising an armature support portion (31), a circumferential side wall (35) and a circumferential clamping portion (36), wherein the armature stopper (27) is arranged coaxially with the valve needle (11) below the armature (23), the armature support portion (31) facing towards the armature (23) and providing a stop for the armature (23) in the closing direction, wherein the circumferential clamping portion (36) has a circumferential gutter (37) formed by a base portion (39), an inner wall (40) and an outer wall (41), the inner wall (40) is part of the circumferential side wall (35), has a smaller radial extension than the outer wall (41) and is arranged closer to the valve needle (11) and the outer wall (41) extends circumferentially around the inner wall (40) and forms a press-fit area for press-fitting the armature stopper (27) into the valve body (4).

In some embodiments, the outer wall (41) is arranged coaxially around and extending completely circumferentially around the inner wall (40).

In some embodiments, the armature stopper (27) is spaced apart from the valve body (4) in both axial directions.

In some embodiments, the armature support portion (31) of the armature stopper (27) has a central opening (33), the diameter of the central opening (33) being larger than the diameter of the valve needle (11).

In some embodiments, at least one passage (43) is arranged in the circumferential side wall (35) allowing fluid to pass through the circumferential side wall (35).

In some embodiments, there is an upper armature retainer (24) fixed to an axial end of the valve needle (11) facing away from the fluid outlet portion (5) and an armature spring (45) biasing the armature (23) towards the upper armature retainer (24), the armature spring (45) being partly arranged inside the gutter (37), the circumferential side wall (35) guiding the armature spring (45).

In some embodiments, there is an upper armature retainer (24) fixed to an axial end of the valve needle (11) facing away from the fluid outlet portion (5) and an armature spring (51) biasing the armature (23) away from the upper armature retainer (24).

In some embodiments, the armature stopper (27) comprises an austenitic material.

In some embodiments, the armature stopper (27) comprises a plastic material.

As another example, some embodiments include a fluid injection valve (1) with a valve assembly (3) as described above.

### BRIEF DESCRIPTION OF THE DRAWINGS

Further advantages, embodiments, and developments of a valve assembly for an injection valve and a fluid injection valve will become apparent from the exemplary embodiments which are described below in association with the schematic figures.

FIG. 1 shows a longitudinal section of an injection valve incorporating teachings of the present disclosure;

FIG. 2 shows a detail of FIG. 1;

FIG. 3 shows a longitudinal section of an injection valve incorporating teachings of the present disclosure; and

FIG. 4 shows a detail of FIG. 3.

### DETAILED DESCRIPTION

In some embodiments, a valve assembly for an injection valve includes a valve body with a central longitudinal axis comprising a cavity with a fluid inlet portion and a fluid outlet portion. A valve needle is arranged in the cavity and axially displaceable in reciprocating fashion relative to the valve body. The valve needle prevents a fluid flow through the fluid outlet portion in a closing position and releases the fluid flow through the fluid outlet portion in further positions. In the closing position, the valve needle is in sealing contact with a valve seat of the valve body.

In some embodiments, the valve assembly further comprises a calibration spring axially biasing the valve needle in a closing direction towards the fluid outlet portion and a movable armature of an electro-magnetic actuator unit being designed to actuate the valve needle. More specifically, the armature is arranged in the cavity and axially displaceable in reciprocating fashion relative to the valve body. It is operable to interact mechanically with the valve needle for displacing the valve needle away from the closing position.

The calibration spring exerts a spring force on the valve needle which is directed in an axial direction directed towards the fluid outlet portion in the closing direction. The electromagnetic actuator unit is operable to displace the valve needle away from the closing position in an opening direction—the axial direction opposite to the closing direction—by means of mechanical interaction of the armature with the valve needle, in particular to open a gap between the valve needle and the valve seat.

In some embodiments, the valve assembly comprises an armature stopper comprising an armature support portion, a circumferential side wall and a circumferential clamping portion. The armature stopper is arranged coaxially with—and in some embodiments extending completely circumferentially around—the valve needle below the armature. The armature support portion faces towards the armature and provides a stop for the armature in the closing direction. The clamping portion has a circumferential gutter formed by a base portion, an inner wall and an outer wall. The inner wall is part of the circumferential side wall. The outer wall forms a press-fit area for press-fitting the armature stopper into the valve body.

That the armature stopper is arranged “below the armature” means in the present context that the armature stopper is arranged subsequent to the armature in the closing direction.

In case of an inward opening valve, it is thus arranged on the side of the armature facing towards the fluid outlet portion.

The inner wall of the gutter has a smaller radial extension than the outer wall and is arranged closer to the needle. The outer wall is preferably arranged coaxially around the inner wall; it may extend circumferentially—in particular completely circumferentially—around the inner wall.

In some embodiments, the armature stopper provides a support for the armature in a fix position. Thus, for example in some embodiments comprising a free lift design, it can stop the armature before the needle has completed its travel, before closing of the valve. Furthermore, the armature stopper dissipates part of the kinetic energy of the armature—needle—assembly during the closing phase by hydraulic dampening. Consequently, needle bounce and unintended post injections are reduced.

The circumferential clamping portion forming the gutter provides elasticity to the armature stopper making it easier to press-fit the armature stopper in a defined position in the valve body.

In some embodiments, the armature stopper—and in particular the base portion of the clamping portion—is spaced apart from the valve body in particular in the closing direction and/or in both axial directions. Thus, the armature stopper may be solely fixed with the valve body by means of the press fit connection of the outer wall with the valve body. In this way, the axial position of the armature support portion can easily be adjusted during manufacturing.

In some embodiments, the circumferential side wall is arranged coaxially around the needle. It protrudes from the armature support portion in the closing direction, in particular towards the fluid outlet portion. To put it differently, the circumferential side wall protrudes in the opening direction from the clamping portion to the armature support portion. In some embodiments, it merges with the armature support portion at an axial end of the armature stopper remote from the clamping portion. The armature support portion can be axially offset with respect to the clamping portion towards the armature.

In some embodiments, the armature stopper is a one-pieced part, in particular a one-pieced metal part or a one-pieced metal plastic part. The expression “one-pieced” means in the present context that the armature stopper is not assembled from a plurality of parts which are connected to one another during the manufacturing process of the armature stopper or during assembling the valve assembly. Rather, the armature stopper is a single workpiece or made from a single workpiece. In this way, the armature stopper may be particularly robust, may have particular small tolerances and/or may be particularly cost-effective.

In some embodiments, the armature support portion of the armature stopper has a central opening, the diameter of the central opening being larger than the diameter of the valve needle, e.g. by at least 5%, in particular by at least 10%. The valve needle is led through the central opening without making contact to the armature stopper. The armature stopper is mechanically decoupled from the needle and cannot transfer energy to or from the needle, e.g. by friction. Energy which is transferred to the armature stopper by the armature during closing phase therefore cannot be transferred to the valve needle, which reduces needle bounce and unintended post injections.

In some embodiments, at least one passage—for example a radial flow hole—is arranged in the circumferential side wall allowing fluid to pass through the circumferential side wall. Thus, fluid can be transferred from the inside of the circumferential side wall to its outside and vice versa. This is an easy way to ensure a flow path past the armature and/or to provide a hydraulic dampening for the armature.

Usually, fluid flow passes from above through passages inside the armature. In some embodiments, the fluid passages through the armature end on the outside of the circumferential side wall. The fluid then needs to get to the inside of the circumferential side wall in order to get to the fluid outlet portion. The fluid passages in the circumferential side wall provide for this. Additionally, they can dampen the movement of the armature by dissipating energy of fluid which is squeezed through them. The dampening effect depends on the cross-section and number of passages.

In some embodiments, the armature is fixed to the valve needle. In some embodiments, the armature is axially displaceable relative to the valve needle in reciprocating fashion. In such embodiments, the valve assembly may expediently further comprise an upper armature retainer. The upper armature retainer is fixed to the valve needle on a side of the armature opposite of the armature stopper. In particular, the upper retainer is fixed to an axial end of the valve needle facing away from the fluid outlet portion; such a configuration is in particular suitable for inward opening valves, i.e. for valves in which the opening direction of the valve needle is directed from the fluid outlet portion towards the fluid inlet portion and in which the valve needle is positioned completely within the cavity of the valve body.

In some embodiments, the valve assembly comprises an armature spring biasing the armature towards the upper armature retainer, the armature spring being partly arranged inside the gutter. In some embodiments, the circumferential side wall may be operable to guide the armature spring axially in this embodiment. In such embodiments, the armature spring serves as an anti-bounce-spring dissipating kinetic energy of the armature during closing phase. The arrangement of the armature spring partly inside the gutter allows the circumferential side wall to provide a guide for the spring, preventing it from buckling. This results in a particularly robust anti-bounce feature and a particularly stable injection behavior of the valve.

In some embodiments, the valve assembly comprises an armature spring biasing the armature away from the upper armature retainer towards the armature stopper. The valve assembly employs a free-lift concept and the armature spring serves as free lift-spring. The armature travels a gap before it engages the needle to open the valve. In the instant it engages the needle, it already has accumulated kinetic energy and may be operable to transfer a particularly large momentum to the valve needle. The free lift-concept enables particularly high maximum pressures in injection valves.

In some embodiments, the armature stopper may comprise an austenitic material. In particular, it may consist of an austenitic steel. The armature stopper is durable and elastic, the elasticity facilitating the fitting of the armature stopper inside the valve body. The material does not disturb the magnetic field because of its low magnetic permeability.

In some embodiments, the armature stopper comprises a plastic material. In this case, the armature stopper can be produced by injection molding or another suitable process. A plastic material is non-magnetic and has a comparatively low weight. The armature stopper thus might be manufactured at very low cost as a standard component.

In some embodiments, there is a fluid injection valve with the described valve assembly. The injection valve may in particular be a fuel injection valve of a vehicle. The injection valve may employ the free-lift design. It would also be possible to use the invention with a different injector design. The needle bounce and post injections can be reduced or avoided, so that emissions can be kept low.

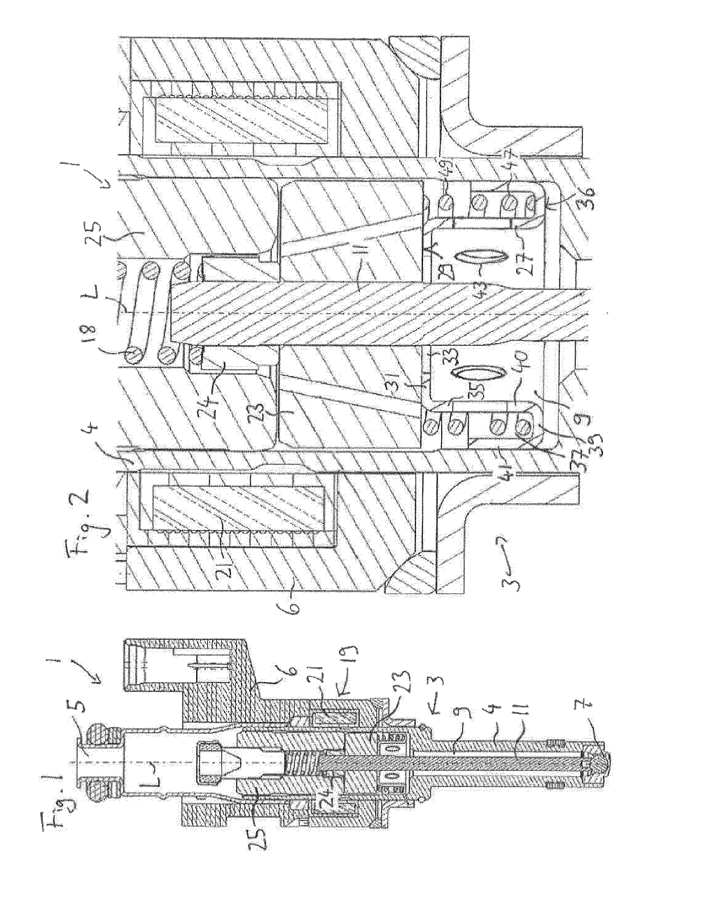

The fluid injection valve 1 shown in FIGS. 1 and 2 is in particular suitable for dosing fuel to a combustion engine. However, the embodiment shown could be used in other types of injection valves, too. The injection valve 1 comprises a valve assembly 3. The valve assembly 3 comprises a valve body 4 with a central longitudinal axis L. A housing 6 is partially arranged around the valve body 4.

The valve body 4 comprises a cavity 9. The cavity 9 has a fluid outlet portion 7. The fluid outlet portion 7 communicates with a fluid inlet portion 5 which is provided in the valve body 4. The fluid inlet portion 5 and the fluid outlet portion 7 are in particular positioned at opposite axial ends of the valve body 4. The cavity 9 takes in a valve needle 11. The valve needle 11 comprises a needle shaft and a sealing ball welded to the tip of the needle shaft.

In a closing position of the valve needle 11, the sealing ball sealingly rests on a valve seat provided by a seat plate having at least one injection nozzle. A preloaded calibration spring 18 exerts a force on the needle 11 axially towards the closing position, the force being directed in a closing direction. The fluid outlet portion 7 is arranged near the seat plate. In the closing position of the valve needle 11, a fluid flow through the at least one injection nozzle is prevented. The injection nozzle may be, for example, an injection hole. However, it may also be of some other type suitable for dosing fluid.

The valve assembly 3 is provided with an electro-magnetic actuator unit 19. The electro-magnetic actuator unit 19 comprises a solenoid 21, which may be arranged inside the housing 6 and circumferentially surrounds the valve body 4. Furthermore, the electro-magnetic actuator unit 19 comprises an armature 23 which is positioned inside the cavity 9. The actuator unit 19 further comprises a pole piece 25. The housing 6, parts of the valve body 4, the pole piece 25 and the armature 23 form a magnetic circuit.

The armature 23 is axially movable in the cavity 9 relative to the valve body 4. The needle 11 extends through a central axial opening in the armature 23. It may be in sliding mechanical contact with the central axial opening of the armature 23.

The armature 23 is axially movable relative to the valve needle 11, i.e. it may slide on the needle 11. At an axial end of the valve needle 11, the valve needle 11 comprises an upper armature retainer 24. The upper armature retainer 24 is fixedly coupled to the axial end of the valve needle 11. The armature 23 is operable to engage the upper armature retainer 24 by a form fit connection for displacing the valve needle 11 away from the closing position against the bias of the calibration spring 18.

Adjacent to a lower side 29 of the armature 23, i.e. the side of the armature facing away from the upper armature retainer 24, an armature stopper 27 is arranged. The armature stopper is substantially “hat-shaped” with an armature support portion 31 facing towards the lower side 29 of the armature 23 and comprising a central axial opening 33, a circumferential side wall 35 and a circumferential clamping portion 36.

The circumferential clamping portion 36 enables the armature stopper 27 to be easily press-fitted into the valve body 4 during manufacture, the position of the armature stopper 27 determining a stop position of the armature 23. The armature stopper 27 is axially spaced apart from the valve body 4 in both axial directions so that its position can be adjusted by the press-fit during manufacturing the valve assembly 3

The circumferential clamping portion 36 comprises an inner wall 40 which is represented by a part of the circumferential side wall 35, an outer wall 41 and a base portion 39 being arranged between the inner wall 40 and the outer wall 41. The inner and outer walls 40, 41 in particular merge with the base portion 39 at an end of the armature stopper 27 remote from the armature and extend in direction towards the armature 23 from the base portion 39. The circumferential clamping portion 36 forms a gutter 37. An axial gap is established between the base portion 39 and the valve body 4, in particular between the base portion 39 and a step of the inner circumferential surface of the valve body 4.

The circumferential side wall 35 projects beyond the clamping portion 36 in direction towards the armature 23 and merges with the armature support portion 31 at an axial end of the armature stopper 27 facing towards the armature 23 and, thus, opposite of the base portion 39. In the circumferential side wall 35, a number of fluid passages 43 are arranged.

The armature stopper 27 is arranged coaxially with the valve needle 11. The valve needle 11 extends through the central opening 33 without making contact with the armature stopper 27.

An armature spring 45 serving as an anti-bounce spring is arranged partly in the gutter 37 and partly protruding from the gutter 37. A lower part 47 of the armature spring 45 is arranged in the gutter 37 whereas an upper part 49 protrudes from the gutter 37. However, the gutter 37 could take up most of the armature spring 45.

In the closing configuration of the valve 1, the needle 11 rests sealingly on the seat plate blocking the fluid outlet portion 7. The armature is pressed against the armature retainer 24 by the armature spring 45. An axial gap is established between the armature support portion 31 or the armature support 27 and the armature 23.

When the solenoid 21 is energized, the armature 23 experiences a magnetic force and slides upwards towards the pole piece 25, moving in axial direction away from the fluid outlet portion 7, thereby compressing the calibration spring 18 and taking the needle 11 with it by way of the upper armature retainer 24. The fluid outlet portion 7 is opened.

When the solenoid 21 is de-energized, the calibration spring 18 forces the valve needle 11 to move in axial direction into its closing position. The valve needle 11 takes the armature with it due to the form-fit connection with the upper armature retainer 24.

During closing transient, when the valve needle 11 reaches the closing position, the armature 23 detaches from the upper armature retainer 24 and travels further downwards, i.e. towards the armature stopper 31, due to its inertia. During this downward travel, fluid is squeezed by the armature 23 through the passages 43 in the circumferential side wall 35, dissipating kinetic energy of the armature 23. Also, the armature 23 slightly compresses the armature spring 45. Buckling of the armature spring 45 is prevented by the armature spring 45 being guided by the armature stopper 27.

When the armature 23 hits the armature stopper 27, the remaining kinetic energy of the armature 23 is transferred to the armature stopper 27. No energy is transferred from the armature 23 to the needle 11, because there is no contact between the armature 23 or the armature stopper 27 and the needle 11. Subsequently, the armature spring 45 brings the armature 23 back in contact with the upper armature retainer 24 to finish the closing transient and re-establish the closing configuration. Thus, the armature spring 45 is supported in a stable position without the armature 23 being able to transfer energy to the valve needle 11 during its downward travel in the closing direction, in particular when it is stopped at the end of its downward travel relative to the valve needle 11.

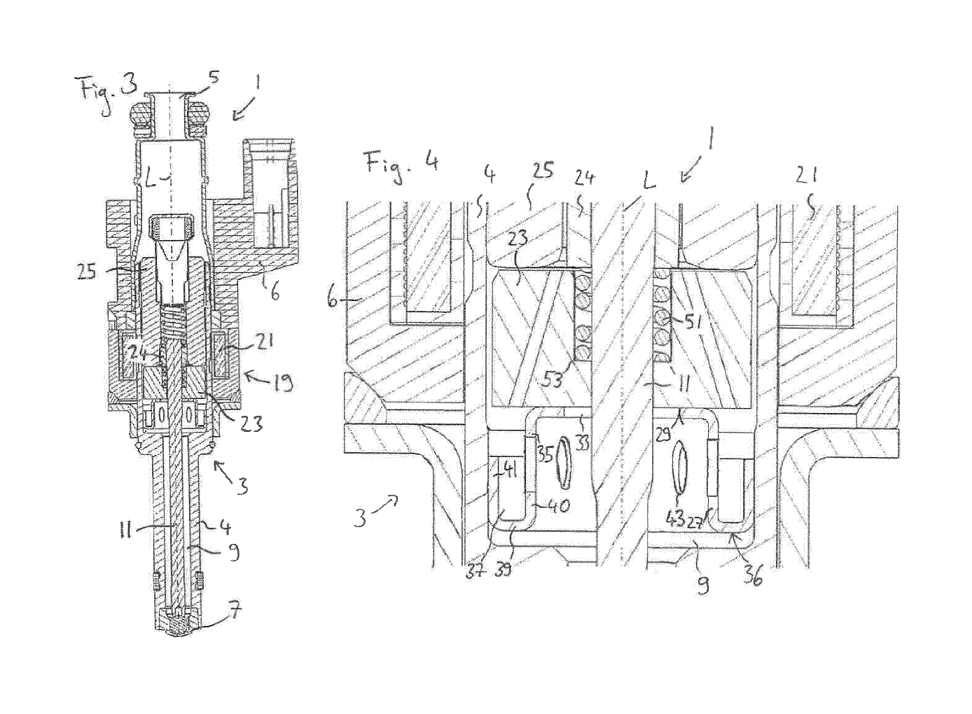

FIGS. 3 and 4 show longitudinal sections of an injection valve 1 incorporating teachings of the present disclosure. This embodiment corresponds in general to that of the first embodiment shown in FIGS. 1 and 2. In FIGS. 3 and 4, individual reference symbols shown in FIGS. 1 and/or 2 may be omitted to improve the clarity of the figures. The injection valve 1 according to the second embodiment differs from that of the first embodiment in that the injection valve 1 employs a free lift-design.

In the closing configuration of the valve 1, there is a gap between the upper armature retainer 24 and the armature 23, which is the so-called free-lift gap. The armature 23 is biased away from the pole piece 25 and from the upper armature retainer 24 by an armature spring 51 arranged in a recess 53 in the armature 23 serving as free lift-spring. Thereby, the armature 23 is biased towards the armature stopper 27 so that it is in form-fit connection with the armature support portion when the valve 1 is in the closing configuration. The armature spring 51 could also be arranged above the armature 23.

When the solenoid 21 is energized, the armature 23 experiences a magnetic force and slides upwards towards the pole piece 25, moving in the opening direction, i.e. the axial direction away from the fluid outlet portion 7, relative to the valve body 4 and to the valve needle 11, thereby compressing only the armature spring 51, not the calibration spring. When the armature 23 starts to travel upwards, a gap is formed between the armature 23 and the armature stopper 27 while the valve needle 11 remains in sealing contact with the seat plate. Only after having travelled the free-lift gap and after having taken up kinetic energy, the armature 23 hits the upper armature retainer 24 and takes the valve needle 11 with it via the form-fit connection with the upper armature retainer 24. Consequently, the valve needle 11 and the armature move in axial direction away the closing position of the valve 1 against the bias of the calibration spring 18.

When the coil 21 is de-energized, the calibration spring 18 is able to force the valve needle 11 to move in axial direction into its closing position.

The valve needle 11 takes the armature 23 with it due to the form-fit connection with the upper armature retainer 24. In addition, the armature 23 is biased away from the upper armature retainer 24 by the armature spring 51. Therefore, the armature 23 detaches from the upper armature retainer 24 during the closing transient and travels downwards towards the armature stopper 27, closing the gap between the armature 23 and the armature stopper 27. In some embodiments, movement of the armature 23 may even be stopped by the armature stopper 27 at a fixed position before the needle 11 has completed its travel towards the fluid outlet portion 5.

As in the first embodiment, the armature 23 does not transfer kinetic energy to the needle 11 during the closing phase adding more impact energy to the kinetic energy of the needle 11. Hence, the armature stopper 27 takes up the closing impact energy generated by the armature 23 during the closing phase and reduces needle bounce and post injections.

What is claimed is:

1. A valve assembly for an injection valve, the valve assembly comprising:
a valve body with a central longitudinal axis comprising a cavity, a fluid inlet portion, and a fluid outlet portion;
a valve needle axially moveable in the cavity, the valve needle preventing a fluid flow through the fluid outlet portion in a closed position and releasing the fluid flow through the fluid outlet portion in further positions;
a calibration spring axially biasing the valve needle in a closing direction towards the fluid outlet portion;
a movable armature of an electro-magnetic actuator unit to actuate the valve needle;
an armature stopper comprising an armature support, a circumferential side wall, and a circumferential clamping portion, wherein the armature stopper is coaxial with the valve needle below the armature, the armature support facing towards the armature and providing a stop for the armature in the closing direction;
wherein the circumferential clamping portion includes a circumferential gutter formed by a base portion, an inner wall and an outer wall;
the inner wall is part of the circumferential side wall with a smaller radial extension than the outer wall and is closer to the valve needle; and
the outer wall extends circumferentially around the inner wall to form a press-fit area for press-fitting the armature stopper into the valve body.

2. A valve assembly according to claim 1, wherein the outer wall is coaxial to and extends completely circumferentially around the inner wall.

3. A valve assembly according to claim 1, wherein the armature stopper is spaced apart from the valve body in both axial directions.

4. A valve assembly according to claim 1, wherein the armature support includes a central opening with a diameter larger than a diameter of the valve needle.

5. A valve assembly according to claim 1, further comprising a passage arranged in the circumferential side wall allowing fluid to pass through the circumferential side wall.

6. A valve assembly according to claim 1, further comprising:
an upper armature retainer fixed to an axial end of the valve needle facing away from the fluid outlet portion; and
an armature spring biasing the armature towards the upper armature retainer, the armature spring partly arranged inside the gutter the circumferential side wall guiding the armature spring.

7. A valve assembly according to claim 1, further comprising:
an upper armature retainer fixed to an axial end of the valve needle facing away from the fluid outlet portion; and
an armature spring biasing the armature away from the upper armature retainer.

8. A valve assembly according to claim 1, wherein the armature stopper comprises an austenitic material.

9. A valve assembly according to claim 1, wherein the armature stopper comprises a plastic material.

10. A fluid injection valve comprising:
a valve body with a central longitudinal axis comprising a cavity, a fluid inlet portion, and a fluid outlet portion;
a valve needle axially moveable in the cavity, the valve needle preventing a fluid flow through the fluid outlet portion in a closed position and releasing the fluid flow through the fluid outlet portion in further positions;
a calibration spring axially biasing the valve needle in a closing direction towards the fluid outlet portion;
a movable armature of an electro-magnetic actuator unit to actuate the valve needle;
an armature stopper comprising an armature support, a circumferential side wall, and a circumferential clamping portion, wherein the armature stopper is coaxial with the valve needle below the armature, the armature support facing towards the armature and providing a stop for the armature in the closing direction;
wherein the circumferential clamping portion includes a circumferential gutter formed by a base portion, an inner wall and an outer wall;
the inner wall is part of the circumferential side wall with a smaller radial extension than the outer wall and is closer to the valve needle; and
the outer wall extends circumferentially around the inner wall to form a press-fit area for press-fitting the armature stopper into the valve body.
